(19) United States
(12) Patent Application Publication
(10) Pub. No.: US 2012/0144289 A1
(43) Pub. Date: Jun. 7, 2012

(54) Displaying a Portion of a First Application Over a Second Application

(76) Inventors: James Morley-Smith, High Wycombe (GB); Gianmichael Di Lallo, Astoria, NY (US)

(21) Appl. No.: 12/959,723

(22) Filed: Dec. 3, 2010

(51) Int. Cl. G06F 3/14

(52) U.S. Cl. 715/234

(57) ABSTRACT

A method displays a portion of a first application over a second application. The method includes receiving a first view of the first application. The method includes receiving a selection of a portion of the first view. The method includes placing the selection over a second view of the second application. The method includes displaying the second view with the selection overlaid thereon.

### BACKGROUND

A web browser enables a user to search items on the Internet for viewing. A first common use of the web browser includes finding instructions such as a tutorial for an application. A second common use of the web browser includes loading a dynamic web page such as a streaming site to view any updates that are occurring. However, in either scenario, the user may often be forced to switch between the browser view and an application view. For example, in the first scenario, the instructions of the tutorial may not be configured for concurrent viewing and execution of the application to which the tutorial is related. The user must either constantly switch between the browser view and the application view or be forced to take further measures such as print the instructions or have a computer configured with multiple monitors. In the other example, the user may wish to usea different application, thereby being precluded from viewing the streaming site.

### SUMMARY OF THE INVENTION

The present invention describes a method for displaying a portion of a first application over a second application. The method comprises receiving a first view of the first application. The method comprises receiving a selection of a portion of the first view. The method comprises placing the selection over a second view of the second application. The method comprises displaying the second view with the selection overlaid thereon.

### DESCRIPTION OF THE DRAWINGS

FIG. 1a shows an application view configured to be sectioned manually according to an exemplary embodiment.

FIG. 1b shows a selection of a section of the application view of FIG. 1a according to an exemplary embodiment.

FIG. 2a shows a sectioned application view for selection of a section according to an exemplary embodiment.

FIG. 2b shows a selection of a section of the application view of FIG. 2a according to an exemplary embodiment.

FIG. 3 shows an overlapdisplay of the selection of FIG. 1b or 2b over another application view according to an exemplary embodiment.

FIG. 4 shows a method for displaying a section of a first application view over a second application view according to an exemplary embodiment.

FIG. 5 shows a method for providing a sectioned layout for a first application view according to an exemplary embodiment.

### DETAILED DESCRIPTION

The exemplary embodiments may be further understood with reference to the following description and the appended drawings, wherein like elements are referred to with the same reference numerals. The exemplary embodiments describe an overlay of a section of a first application view on a second application view. Specifically, a section of a web page may be cropped and superimposed over another application, thereby enabling a view of both the section and the application. The application views, the section, the overlay, a method of overlaying, and a method for providing a sectioned layout will be discussed in further detail below.

It should be noted that the use of the web page is only exemplary. The exemplary embodiments may be used to provide the overlay of any section from any application over another application. For example, a word processing document may include a section that is cropped and superimposed over another application such as a spreadheet. Thus, the use of the web page in the description herein may generally refer to any application that includes at least one section.

It should also be noted that the overlay of a section of a first application view over a second application view may be performed using an overlay application. The overlay program may be a functionality of any component related to the display of a computing device. For example, the overlay application may be associated with a video card, an operating system, etc.

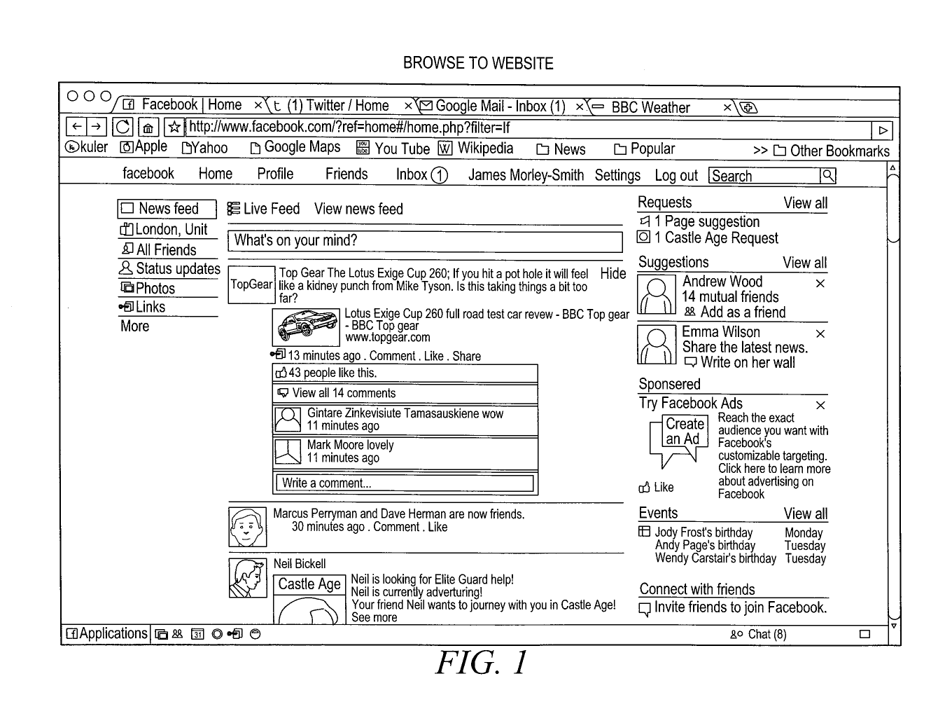

FIG. 1a shows an application view 100 configured to be sectioned manually according to an exemplary embodiment. The application view 100 may include a coordinate system to measure x-coordinates and y-coordinates. Thus, when a user enters a set of coordinates that include a desired section, a correct section may be determined. It should be noted that the overlay application may initially be activated to enable the manual selection. It should also be noted that a preset command may be entered to indicate that the manual selection is enabled.

FIG. 1b shows a selection of a section 110 of the application view 100 of FIG. 1a according to an exemplary embodiment. The section 110 may include four coordinates each including a respective x-coordinate and y-coordinate. For example, the bottom left corner of the section 110 may be an origin (e.g., (0,0)). The section 110 may therefore include a second coordinate (0,y) (e.g., top left corner), a third coordinate (x,0) (e.g., bottom right corner), and a fourth coordinate (x,y) (e.g., top right corner). It should be noted that the initial point being an origin is only exemplary. In another example, a random position (e.g., center of the application view 100, bottom left corner of the application view 100, etc.) on the application view 100 may be an origin and x-values and y-values may be determined as a function of the origin.

The user may manually select the section 110 by providing the coordinates that include the section 110. For example, an input device such as a keyboard or a mouse may be used. When using a mouse, the user may provide an initial input by moving a cursor to a starting point and dragging a box for the section 110. When using a keyboard, a grid overlay may be provided so that the user may enter the four coordinates. It should be noted that the rectangular shape of the section 110 is only exemplary. In particular for the manual selection of the section 110 in which the user provides the coordinates, the shape of the section 110 may be anything that includes the desired portion of the application view 100. Accordingly, more than one mouse input, fewer than four coordinates, or more than four coordinates may be entered for the manual selection.

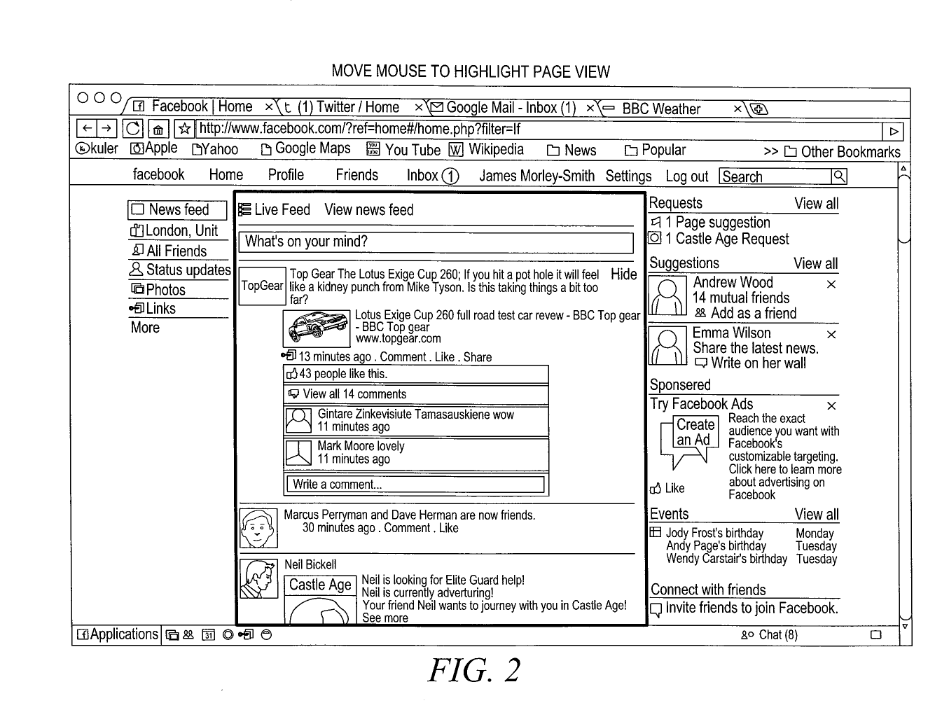

FIG. 2a shows the application view 100 that is sectioned for selection of an available section 105-140 according to an exemplary embodiment. The application view 100 according to this exemplary embodiment may include predetermined sections 105-140 that the user is enabled to select. Thus, when the user sees the available sections 105-140, the user may enter a selection. Each section may include a variety of functionalities available on the web page. For example, as illustrated, the section 105 may include a menu to navigate different sub-pages on the web page while section 110 may be a wall for a social networking stream. Sections 115-140 may include further options available on the web page such as updates, available contacts, advertisements, etc.

FIG. 2b shows a selection of the section 110 of the application view 100 of FIG. 2a according to an exemplary embodiment. When the predetermined sections 105-140 are shown on the application view 100 (e.g., overlay grid), the user may use an input device such as a keyboard or mouse to select one of the sections.

The sections 105-140 may be determined in a variety of manners. In a first example, the sections 105-140 may be stored in a database so that when a section is to selected, the sectioned view of the application view 100 may be retrieved. In a second example, the sections 105-140 may be determined automatically using a variety of parameters such as margins, breaks, etc. In a third example, the sections 105-140 may be determined using source data for the application view when available such as with a mark-up language for a web page. In a fourth example, the sections 105-140 may be predetermined by the user prior to a current selection of one of the sections 105-140. That is, the user may save user selected sections for a particular application that are made available each time the application view is displayed.

It should be noted that the selection of only one section is only exemplary. According to the exemplary embodiments, more than one section may be selected. During the manual input, a prompt may be issued after a selection of a first section that requests any further sections that are to be included. During the sectioned input, the user may select more than one of the predetermined sections.

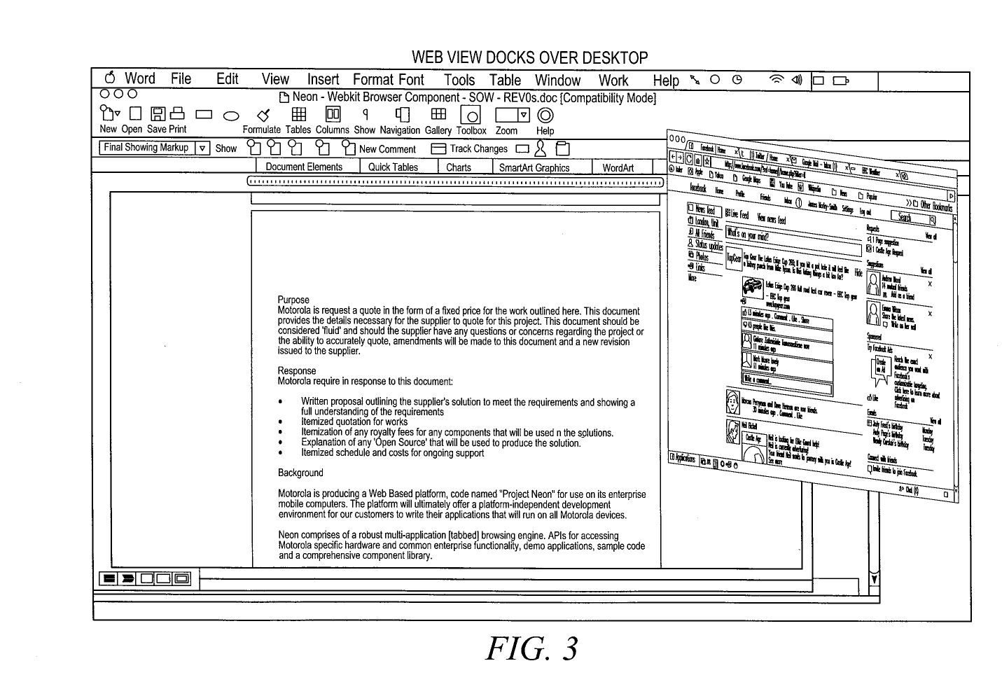

FIG. 3 shows an overlap display of the section 110 of FIG. 1b or 2b over another application view 200 according to an exemplary embodiment. As discussed above, the section 110 may be selected manually or from a predetermined layout. The placement of the section 110 overlaid on the further application view 200 may be predetermined. For example, the section 110 may be placed on a right side of the further application view 200 where little to no important aspects of the further application view 200 are shown. In another example, the section 110 may be placed anywhere so long as the further application view 200 is not impeded. However, it should be noted that the section 110 may include other features for the placement. For example, the user may be enabled to move the section 110 as desired. In another example, the section 110 may be locked in a predetermined position. In yet another example, the section 110 may be locked and/or unlocked to be placed in a position.

The overlay of the section 110 may also include further features. For example, as illustrated in FIG. 3, the section 110 may be placed at an angle. However, the angle is such that the view of the section 110 is not detracted. In another example, also illustrated in FIG. 3, the coloring and/or shading may be changed such as inverting a shading scale. Thus, when the section 110 is placed over a lighter colored area of the further application view 200, the coloring and/or shading may be adjusted accordingly and vice versa.

The exemplary embodiments also enable both applications to run concurrently. That is, the section 110 may continuously run while overlaid on the further application view 200. For example, if the section 110 is part of a streaming application such as a social networking stream, the section 110 may continuously be updated, thereby updating the view shown when the section 110 is overlaid. It should also be noted that the section 110 may be a screen capture. For example, when the section 110 has a constant view such as a tutorial, an updated view may not be required. Thus, using a screen capture, less resources may be required for the overlay of the section 110.

The exemplary embodiments also enable the application in which the portion of the first application is overlaid to function solely for receiving inputs. That is, although the section 110 is overlaid and both applications are running concurrently, inputs received by the computing device may be directed only toward the further application that has the section 110 overlaid thereon. Accordingly, functionality of the further application is not impeded. However, it should be noted that the overlay of the section 110 may also be configured in other ways. For example, if the application including the section 110 and the further application utilize different inputs, both applications may maintain reception of inputs as a first input relates only to the application including the section 110 while a second input relates only to the further application. In another example, a command may be issued to transfer input reception to the application including the section 110. Thus, the concurrently running application including the section 110 is not required to bring the application view 100 over the further application view 200 but remain capable of receiving inputs.

It should be noted that the use of two applications is only exemplary. The exemplary embodiments may be configured to provide an overlay for more than one section and/or more than one application view. For example, as discussed above, multiple sections of the application view may be selected by the user. The overlay may therefore include the selected sections to be overlaid on the further application view. The multiple sections may be shown with each selected section separated from each other, at least two selected sections joined together, all the selected sections joined together, etc. In another example, at least one section from a first application view and at least one section from a second application view may be selected. The sections from the first and second application views may be overlaid on a further application view. It should be noted that with these exemplary embodiments, all features described above may be utilized.

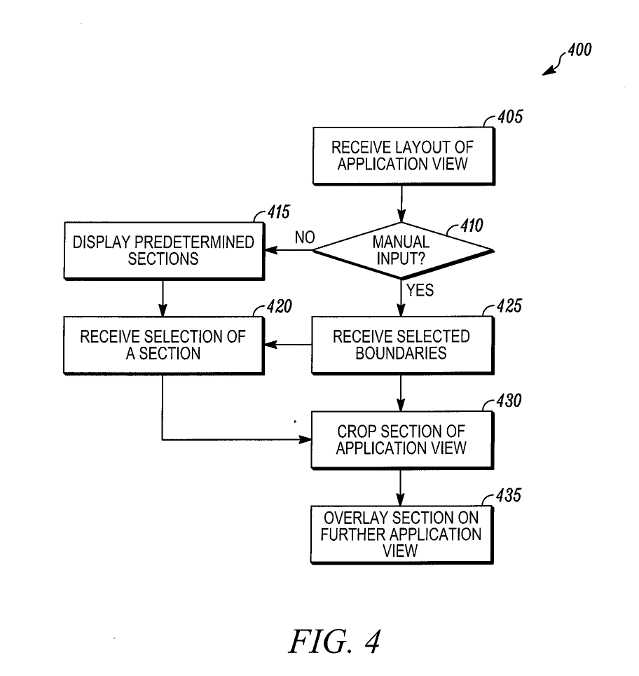

FIG. 4 shows a method 400 for displaying the section 110 of the application view 100 over the further application view 200 according to an exemplary embodiment. The method 400 will be described with reference to the manual selection of the section 110 as discussed above in FIGS. 1a-1b and with reference to the sectioned selection as discussed above in FIGS. 2a-2b. The method 400 will also be described as a function of the overlay program.

In step 405, the overlay program receives a layout of the application view 100. The layout of the application view 100 may be received in a variety of forms. For example, a screen shot of the application view 100 may be taken. In another example, source data of the application view 100 may be received (e.g., mark-up language for a web page).

According to the exemplary embodiments, because a selection for a section of the application view 100 may be done in at least two ways, in step 410, a determination is made whether the selection is to be performed manually. If the manual selection option is not chosen, the method 400 continues to step 415. If the manual selection option is chosen, the method 400 continues to step 425.

In step 415, the application view 100 that is sectioned is displayed. As discussed above, the overlay program may determine the predetermined sections 105-140 of the application view 100 and/or retrieve stored data relating to the predetermined sections 105-140 of the application view 100. In step 420, the overlay program receives a selection of one or more of the sections 105-140. That is, the user inputs data indicating a selection for the desired section. For purposes of this discussion, the section 110 may be selected.

If the manual selection option is chosen, the overlay program receives boundaries for a desired section in step 425. As discussed above, the user may utilize an input device to provide coordinates (e.g., x- and y-coordinates) that encompass the desired section. For example, a mouse may be used to create a shape that includes the desired section. In another example, a keyboard may be used to input the coordinates when a grid overlay is provided on the application view 100. For purposes of this discussion, the section 110 may be manually entered.

In step 430, the overlay application crops the section 110 of the application view 100. That is, the overlay application generates an image including only the section 110. As discussed above, the section 110 may include a streaming profile. Accordingly, the overlay application may update the image of the section 110. In step 435, the section 110 is overlaid on the further application view 200. As discussed above, the section 110 may be overlaid at a predetermined position on the further application view 200; may be overlaid in an unlocked state to enable the user to move the section 110 to a desired position; may be locked/unlocked; etc.

It should be noted that the method 400 may include further steps to accommodate the further features described above. For example, when multiple sections are to be selected, prior to step 430, a determination may be made whether further sections are to be selected. If further sections are not to be included, the method 400 continues to step 430. If further sections are included, the method 400 may return to step 410 to determine if the further section is to be received manually or not. It should be noted that this enables the user to include a desired section that is selected from the sectioned application view 100 as well as a manually entered section. That is, the selection of the sections may be only selections from the sectioned application view 100, only manually determined sections, and a combination thereof.

In another example of the features described above, the method 400 may include subsequent steps after step 435 to receive input relating to the display of the section 110 on the further application view 200. As already discussed above in step 435, the display input may be for a position of the section 110 relative to the application view 200. In another example, the display input may be for an angular orientation of the section 110 as illustrated in FIG. 3. In yet another example, the display input may be for a coloring and/or shading scheme for the section 110 also illustrated in FIG. 3.

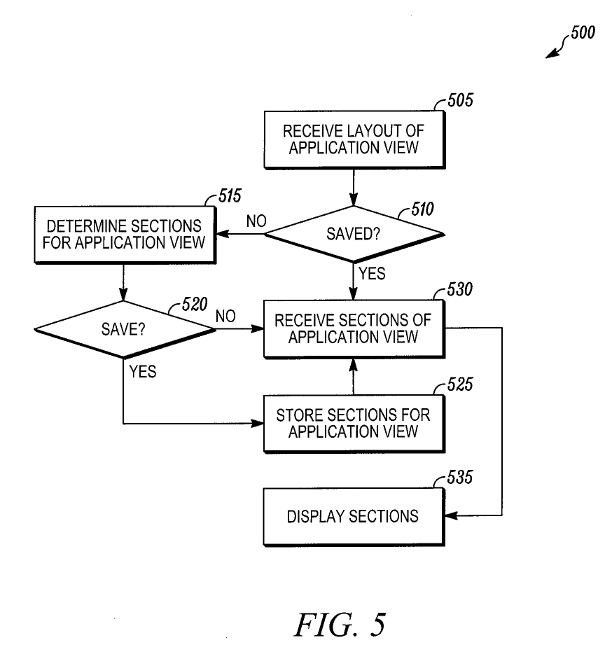

FIG. 5 shows a method 500 for providing a sectioned layout for the application view 100 according to an exemplary embodiment. The method 500 relates to when the user is shown the application view 100 that is sectioned. That is, the user does not choose the manual input option (i.e., step 410 of method 400). The method 500 will be described with reference to the sectioned view of FIGS. 2 and 2a. The method 500 will also be described with reference to the overlay program.

In step 505, the overlay program receives a layout of the application view 100. As discussed above, the layout of the application view 100 may be received in a variety of forms. For example, a screen shot of the application view 100 may be taken. In another example, source data of the application view 100 may be received.

In step 510, a determination is made whether the application view 100 has saved data relating to sections thereof. For example, if the application view 100 has already had sections determined, a profile may be saved for the application view 100 for subsequent use. When this occurs, the method 500 continues to step 530. In another example, if the application view 100 is a first occurrence of determining sections, no profile may be saved. When this occurs, the method 500 continues to step 515.

In step 515, the overlay application determines sections for the application view 100. As discussed above, the overlay application may determine the sections in a variety of manners. In a first example, the overlay application may take a screen shot of the application view 100 and determine edges (e.g., boundaries, margins, etc.) to correctly determine the sections. In a second example, the overlay application may refer to the source data of the application view 100 to determine the sections.

In section 520, a determination is made whether the profile for the application view 100 is to be saved. As discussed above, the overlay application may store profiles of application views for subsequent uses. If the profile is not chosen to be saved, the method 500 continues to step 530. If the profile is chosen to be saved, the method 500 continues to step 525 where the profile is saved that indicates the sections that are determined for the application view 100. It should be noted that the profile may be saved locally (e.g., memory) or remotely (e.g., network database).

In step 530, the overlay application receives the sections of the application view 100 that are retrieved from a stored location or determined. In step 535, the sections of the application view 100 are shown to the user for selection.

The exemplary embodiments enable a section of a first application view to be cropped and overlaid over a second application view. The section selected from the first application view may be determined manually or chosen from sections determined for the first application view. When determined manually, coordinates may be input that determine the shape and size of the section. When chosen from sections, an overlay application may determine the plurality of sections available on the first application view.

By enabling the section of the first application view to be shown over the second application view, a user is not required to switch between the first application view and the second application view, for example, when multi-tasking. The first application may also run concurrently with the second application view, thereby not impeding the functionalities of either application. The section shown on the second application view may also be displayed in a predetermined manner or user-specified.

Those skilled in the art will understand that the above described exemplary embodiments may be implemented in any number of manners, including, as a separate software module, as a combination of hardware and software, etc. For example, the overlay application may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving a first view of a first application;
receiving a selection of a portion of the first view;
placing the selection over a second view of a second application; and
displaying the second view with the selection overlaid thereon.

2. The method of claim 1, wherein the first view is a web page view.

3. The method of claim 1, wherein the portion is received from a manual input.

4. The method of claim 3, wherein the manual input includes coordinates on the portion.

5. The method of claim 1, wherein the selection is one of a plurality of predetermined sections.

6. The method of claim 5, wherein the plurality of predetermined sections are displayed on the first view.

7. The method of claim 1, wherein the first application and the second application operate concurrently.

8. The method of claim 7, wherein the second application is configured to receive input.

9. The method of claim 1, wherein the selection is placed over the second view at a predetermined position.

10. The method of claim 9, wherein the selection is locked at the predetermined position.

11. The method of claim 9, wherein the selection is movable to a different position.

12. The method of claim 9, wherein the selection is placed at an angle with respect to the second view.

13. The method of claim 1, wherein the selection is adjusted at least in color and shade.

14. A method, comprising:
receiving a view of an application;
determining sections for the view as a function of display data of the view, the section configured to be displayed on a further view of a further application; and
displaying the sections on the view.

15. The method of claim 14, wherein the determining uses source data of the view.

16. The method of claim 15, wherein when the application is a web page, the source data is a mark-up language.

17. The method of claim 14, further comprising:
capturing an image of the view.

18. The method of claim 17, wherein the determining includes generating edges of the sections as a function of the image.

19. The method of claim 14, further comprising:
storing a profile for the view.

20. A computer readable storage medium including a set of instructions executable by a processor, the set of instructions operable to:
receive a first view of a first application;
receive a selection of a portion of the first view;
place the selection over a second view of a second application; and
display the second view with the selection overlaid thereon.
